(19) United States
(12) Patent Application Publication
(10) Pub. No.: US 2007/0089777 A1
(43) Pub. Date: Apr. 26, 2007

(54) Heatsink for concentrating or focusing optical/electrical energy conversion systems

(76) Inventors: Richard L. Johnson JR., Suffolk, VA (US); Howard C. Holmes, Boulder Creek, CA (US); Russell E. Neff, Glendale, CA (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/543,299

(22) Filed: Oct. 4, 2006

Related U.S. Application Data
(60) Provisional application No. 60/723,336, filed on Oct. 4, 2005.

(51) Int. Cl. H02N 6/00

(52) U.S. Cl. 136/246

(57) ABSTRACT

The present invention relates to heatsink technology for helping to dissipate thermal energy generated or absorbed with respect to optical focusing and/or concentrating systems such as projectors and spotlights as well as trough or dish reflectors. More specifically, the present invention relates to heat sink technology for helping to dissipate thermal energy generated by or absorbed in the proximity of the focus of optical concentrating elements of solar concentrator modules, wherein the heat sink includes a plurality of heat dissipating fins.

### PRIORITY CLAIM

The present non-provisional patent Application claims priority under 35 USC §119(e) from United States Provisional Patent Application having Ser. No. 60/723,336, filed on Oct. 4, 2005, and titled A HEATSINK FOR CONCENTRATING OR FOCUSING OPTICAL/ELECTRICAL ENERGY CONVERSION SYSTEMS, wherein the entirety of said provisional patent application is incorporated herein by reference.

### FIELD OF THE INVENTION

The present invention relates to heatsink technology for helping to dissipate thermal energy generated or absorbed with respect to optical focusing and/or concentrating systems such as projectors and spotlights as well as trough or dish reflectors.

### BACKGROUND OF THE INVENTION

In general concentrating and projection systems focus light onto, or broadcast light from, a device located in the proximity of the focus of a reflector. Dish and trough reflectors are examples of optical focusing elements. Dish reflectors differ from trough reflectors in that there is surface curvature in two axes as opposed to curvature in a single axis. As such, dish reflectors have a focal point whereas trough reflectors have a focal line. The curvature of the reflector is often parabolic but other geometries are possible including, but not limited to, spherical, elliptical, and hyperbolic. In addition the reflector may be a monolithic surface or be composed of multiple segments.

An optical concentrator or projector may include any one or more of a wide variety of optical elements, such as a lens, reflector, solar trap, condenser lens, compound parabolic concentrator, or the like to concentrate or project incident light to high intensity, where the concentrated or projected light performs some useful purpose. Examples for uses of projected light include spotlights, movie projection systems, and automobile headlights. Examples of uses for concentrated light include heating water, creating electricity, or even cooking food. Optical concentrating elements often are used in connection with photovoltaic concentrator modules of photovoltaic power systems. A photovoltaic power system converts incident light, often sunlight, into electrical power. Photovoltaic concentrator modules(s) help to concentrate sunlight upon one or more photovoltaic cells. The photovoltaic element(s) convert the concentrated light into electricity. A typical photovoltaic system based upon the concentrator concept generally incorporates an array of solar concentrator modules.

Photovoltaic systems incorporating the photovoltaic concentrator module concept have been described in U.S. Pat. Nos. 4,968,355; 4,000,734; and 4,296,731; U.S. Pat. Publication Nos. 2005/0034751; 2003/0075212; 2005/0081908; and 2003/0201007; and in Assignee's U.S. Provisional Patent Application No. 60/691,319, filed Jun. 16, 2005 in the name of Hines, titled PLANAR CONCENTRATING PHOTOVOLTAIC SOLAR PANEL WITH INDIVIDUALLY ARTICULATING CONCENTRATOR ELEMENTS.

All of such patents, published applications, and application are incorporated herein by reference in their respective entireties for all purposes.

Projector systems are essentially concentrators operating in reverse. A typical system may have a light- or heat-generating element at the focus of an optical element. The optical element then projects the light in a possibly collimated or semi-collimated beam towards some remote point to be illuminated, such as a movie screen or the general area in front of the projector, as in the case of a headlight or spotlight.

In most cases, devices used at the focus of optical focusing elements have inefficiencies that result in the generation of thermal energy. This thermal energy may increase the device operating temperature and, as a result, may affect device performance, stability, and longevity. Heatsinks are frequently thermally coupled to these devices; these heatsinks are designed to dissipate thermal energy in order to maintain tolerable device operating temperatures.

One specific application of heatsinks is to dish solar concentrators. When these systems use dish reflectors to concentrate sunlight onto photovoltaic solar cells, the concentrated sunlight typically results in high power per unit area on the solar cell. In addition, the amount of thermal energy that must be dissipated by the solar cell can be similarly magnified. Dissipating this thermal energy can be important to maintaining solar cell efficiency as well as system reliability.

Large air-cooled utility scale dish photovoltaic solar concentrator systems frequently employ heat pipes to provide cooling for the solar cells. These have a generally cylindrical form extending from the focus along the pointing vector of the concentrator. In general, heat pipes can dissipate large amounts of thermal energy and minimally shadow the reflector.

Linear (i.e., trough) photovoltaic solar concentrator systems frequently employ finned metal heatsinks to cool solar cells by means of convection. These heatsinks are in good thermal contact with a linear array of solar cells positioned along the focal line of the reflecting trough. One embodiment of this type of heatsink is described by J. Smeltink and H. Francicus in PCT document WO 01/73665.

### SUMMARY OF THE INVENTION

It is an object of this invention to provide a heatsink for dissipating thermal generated and/or absorbed in systems incorporating optical concentrators and/or projectors, especially equipment incorporating a dish solar concentrator. An exemplary system that can incorporate a heatsink according to the present invention is a photovoltaic power system having at least one photovoltaic concentrator module.

A heatsink according to the present invention includes one or more thermally conductive fins thermally coupled to an energy collection or generation device that is located near the focal region of a focusing element. Fin(s) may be placed both outside of and/or at least partially within the volume of illumination associated with the focus of the optical element. Also, fin(s) may be planar or non-planar with respect to each other.

Spacing between fins can be achieved with individual spacer elements or spacing can be achieved by having at least some fins interleaved.

Fin(s) may be incorporated into a cover that partially or fully encloses the optical system.

According to one aspect of the present invention, a system includes an optical element, a source of thermal energy, an illuminated volume, and a heatsink. The optical element has an optical axis and a focus. The illuminated volume is between the optical element and the focus. The heatsink is thermally coupled to the source of thermal energy in a manner effective to help dissipate the thermal energy. The heatsink includes a plurality of fins having opposed major faces that are parallel to the optical axis. At least a portion of a first fin of the plurality is inside the volume. At least a portion of a second fin of the plurality is outside of the volume.

According to another aspect of the present invention, a system includes an optical element, an illuminated volume, and a heat sink. The optical element has an optical axis and a focus. The illuminated volume is between the optical element and the focus. The heatsink is thermally coupled to the system. At least a portion of the heatsink is positioned in said volume.

According to another aspect of the present invention, a system includes an optical element, an illuminated volume, and a heatsink. The heatsink is thermally coupled to the system. The heat sink includes a fin having a major face parallel to the optical axis and having a first portion that has a perimeter that is adjacent to and follows a boundary of the illuminated volume. The optical element has an optical axis and a focus. The illuminated volume is between the optical element and the focus.

According to another aspect of the present invention, a photovoltaic power system has at least one articulating photovoltaic concentrator module. The photovoltaic concentrator module includes at least one photovoltaic cell, an optical element, a volume under concentrated illumination, and a heatsink. The optical element has a focus on a focal plane that concentrates incident light onto the photovoltaic cell. The optical element has an optical axis. The concentrating by the optical element generates thermal energy. The volume under concentrated illumination is between the optical element and the photovoltaic cell. The heatsink includes at least one heat dissipating fin that is thermally coupled to the photovoltaic cell in a manner effective to help dissipate thermal energy from the module. The fin has opposed major faces that are generally parallel to the optical axis of the optical element. The fin has a portion that is positioned inside a volume between the focal plane and the optical element.

According to another aspect of the present invention, a photovoltaic power system has at least one articulating photovoltaic concentrator module. The photovoltaic concentrator module includes at least one photovoltaic cell, an optical element, a volume under concentrated illumination, and a heatsink. The optical element has a focus on a focal plane and that concentrates incident light onto the photovoltaic cell. The optical element has an optical axis. The concentrating by the optical element generates thermal energy. The volume under concentrated illumination is between the optical element and the photovoltaic cell. The heatsink includes at least one heat dissipating fin that is thermally coupled to the photovoltaic cell in a manner effective to help dissipate thermal energy from the module. The fin has opposed major faces that are generally parallel to the optical axis of the optical element. The fin has a first portion that is positioned outside the volume under concentrated illumination and has a perimeter that is adjacent to and follows a boundary of the illuminated volume. The fin has a second portion that is positioned outside the volume under concentrated illumination and extends above the focus.

According to another aspect of the present invention, a heat sink for dissipating thermal energy includes a stack of spaced apart fins and an open volume below the stack. The fins have major faces parallel to an axis. At least a portion of a fin is positioned in the open volume and has major faces parallel to the axis.

According to another aspect of the present invention, a heat sink for dissipating thermal energy includes a stack of spaced apart fins, an open volume below the stack, and a plurality of additional fins positioned at least partially in the open volume below the stack. The fins have major faces parallel to an axis. The additional fins have major faces parallel to the axis and extend radially from the axis. The additional fins support the stack.

In preferred embodiments, the present invention provides a heatsink that can dissipate thermal energy absorbed in the proximity of the focus of an optical focusing element, such as a trough or dish reflector associated with a photovoltaic concentrator module.

A preferred heatsink includes a stack of two or more parallel fins and at least one additional fin that is nonplanar with respect to the fins of the stack.

A fin is preferably planar and at least a portion of the fin preferably extends substantially from and has major faces parallel to the optical axis of the optical element. A preferred heatsink includes a plurality of fins extending from the optical axis of the optical element towards the perimeter of the optical element.

In preferred embodiments, one or more of the fin(s) extend toward and attach to the optical element. Advantageously, attaching a fin to the optical element can help register and suspend the heatsink including the fin above the optical element.

Preferably, fin(s) can be formed and arranged such that shadowing caused by the fin(s) with respect to the optical element is substantially limited to the projected edge-on footprint of the fin(s) onto the surface of the optical element.

In one embodiment, a multiplicity of parallel non-attaching fins are separated using spacers and are supported by additional non-parallel and/or parallel fins that extend toward the optical element. Preferably, non-attaching fins are formed having similar geometry and/or attaching fins are formed having similar geometry.

In another embodiment, a multiplicity of non-parallel, non-attaching fins can be separated using spacers and can be supported by additional non-parallel fins that extend toward the optical element (see, e.g., FIG. 4 below).

### BRIEF DESCRIPTION OF THE DRAWINGS

FIG. 1A shows a perspective view of an embodiment of a heatsink according to the present invention.

FIG. 1B shows an alternate perspective view of the heatsink in FIG. 1A.

FIG. 1C shows a perspective view of a non-attaching fin forming part of the heatsink of FIG. 1A.

FIG. 1D shows a perspective view of an attaching fin forming part of the heatsink of FIG. 1A.

FIG. 1E shows a perspective view of a fin spacer forming part of the heatsink of FIG. 1A.

FIG. 1F shows a top view of a photovoltaic concentrator module including the heatsink of FIG. 1A attached to an optical concentrating dish.

FIG. 1G shows a perspective view of the photovoltaic concentrator module shown in FIG. 1F and further showing an energy collection device and a sun-tracking sensor.

FIG. 2 schematically shows a cross-section of the dish reflector of FIG. 1F and a ray trace of a non-obscured volume of concentrated illumination associated with the dish reflector.

FIG. 3 schematically shows a cross-section of the dish reflector of FIG. 1F and a ray trace with two obscurations (one outside and one inside the convergence cone of the dish reflector) of a volume of concentrated illumination associated with the dish reflector.

FIG. 4 shows a top view of an alternative embodiment of a heatsink according to the present invention attached to an optical concentrating dish.

FIG. 5 shows a perspective view of an alternative, interleaved fin arrangement that does not require the use of additional spacers.

### DETAILED DESCRIPTION OF PREFERRED EMBODIMENT

For purposes of illustration a heatsink according to the present invention is described below in the context of being applied to concentrating or focusing optical/electrical energy conversion systems. As used herein, the term “focusing” includes imaging focusing and/or non-imaging focusing. The heat sinks are preferably applied to the optical focusing elements such as those used in concentrating systems.

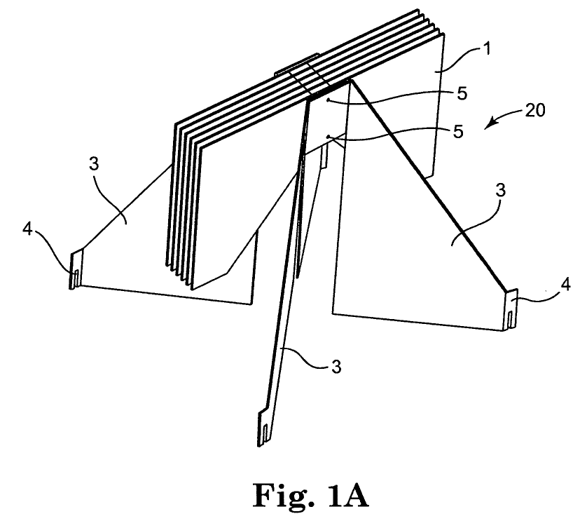

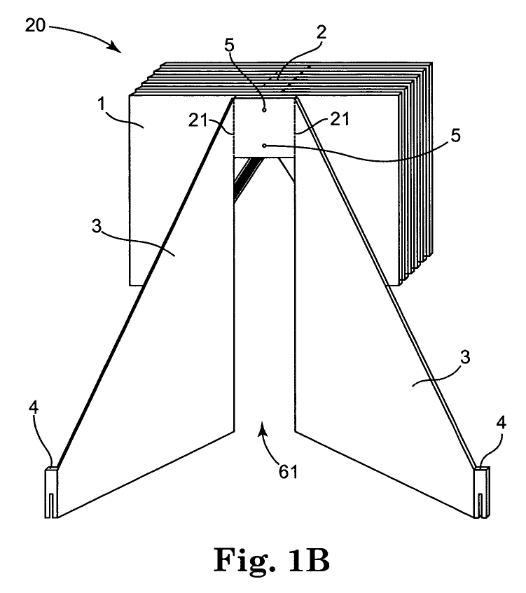

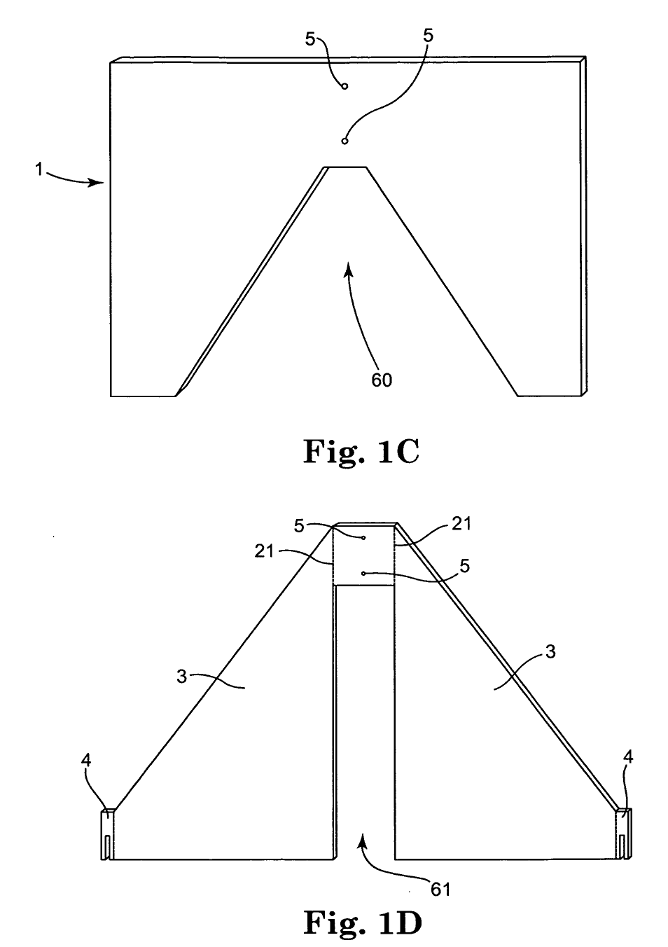

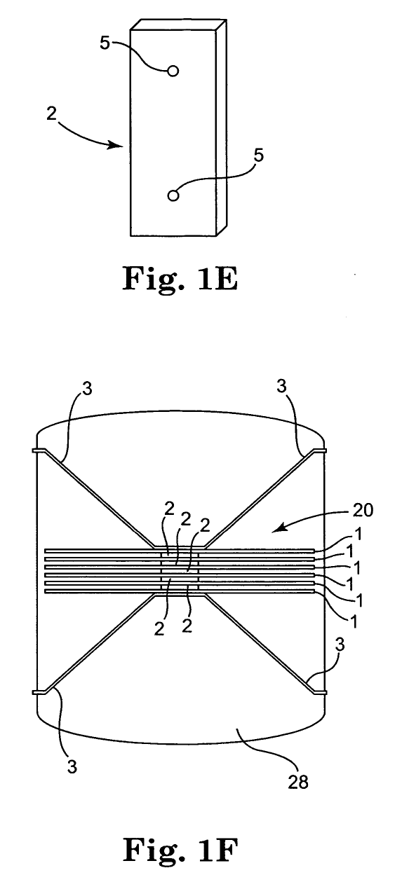

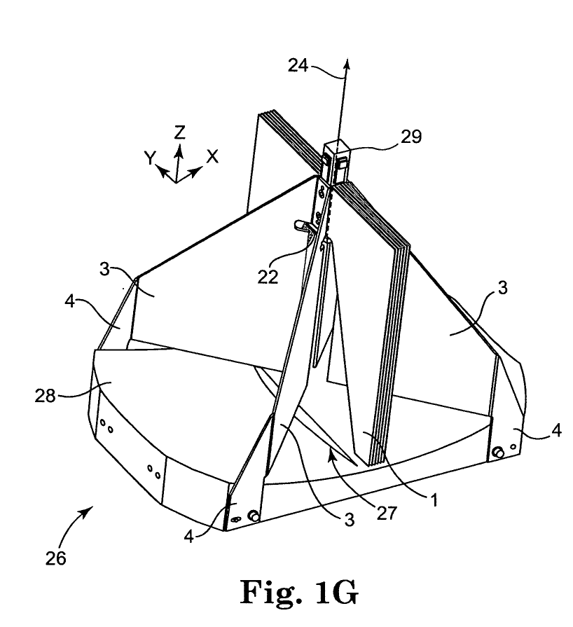

FIGS. 1A-1G show one preferred embodiment of a heatsink 20 that can be used in a photovoltaic concentrator module 26. Heat sink 20 incorporates respective thermally conductive fins 1 and 3.

Preferably, heat sink 20 includes at least one, but more preferably two or more parallel, spaced apart fins 1 that are arranged in a stack and are separated by and attached to spacers 2. As shown in FIG. 1G, at least one of the fins 1 may extend radially outward directly from the optical axis 24, while the other fins 1 are parallel to such one fin 1 yet are slightly offset from axis 24. As shown, the parallel, spaced apart fins 1 have the general shape such that they occupy volume that is outside of the volume of concentrated illumination 10 defined by light reflected from dish 28.

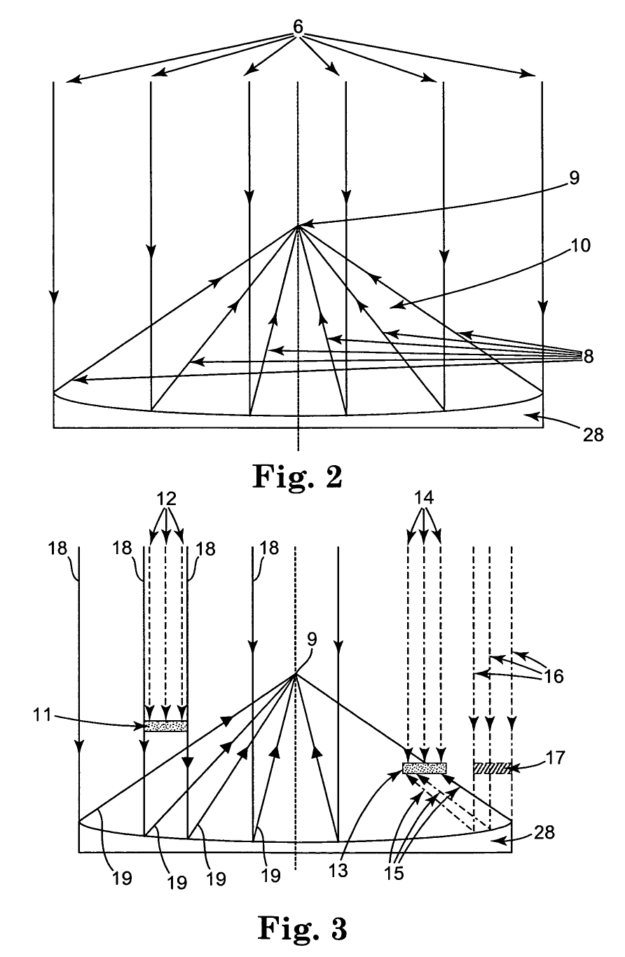

Referring to FIG. 2, the volume under concentrated illumination 10 (or convergence cone) is a three-dimensional volume defined as incident light rays 6 reflect off of the dish reflector 28 focusing reflected rays 8 towards a focal point 9. The volume 10 defines a volume that contains the reflected rays (note: for simplicity a two-dimensional cross-section is shown in FIG. 2). Volume 10 generally at least includes the approximately conical region that is both above the reflector 28 and below the focal point

In concentrating module 26, the position of focal point 9 generally corresponds to the location where energy collection device 22 in FIG. 1G is positioned. The ray trace shown in FIG. 2 is of a non-obscured volume of concentrated illumination 10 associated with the dish reflector 28.

While not being bound by theory, it is believed that one advantage of using fins 1 is that at least a portion of fins 1 can utilize volume that is below the focal point 9 and outside of the volume of concentrated illumination 10. Utilizing such volume advantageously allows fins 1 to minimize the height of module 26 and yet fins 1 do not create an additional virtual obscuration. Fins 1 do not obscure dish reflector 28 more than the edge-on footprint of fins 1.

A virtual obscuration can be illustrated by referring to FIG. 3, which illustrates the consequence of having obscurations that lie outside and inside of volume of concentrated illumination 10. FIG. 3 schematically shows a cross-section of the dish reflector 10 and a ray trace with two obscurations 11 and 13. Obscuration 11 is outside the volume of concentrated illumination 10 associated with the dish reflector 28. Obscuration 13 is partially inside the volume of concentrated illumination 10 associated with the dish reflector 28.

Obscuration 11 blocks incident rays 12. However, obscuration 11 does not block any reflected rays 19 generated from incident rays 18 not affected by obscuration 11. In contrast, obscuration 13, lying partially inside of volume 10, blocks incident rays 14 as well as reflected rays 15 generated from incident rays 16. The net result is that there is an additional, virtual obscuration 17. Virtual obscuration 17 would obscure incident rays 16 that result in reflected rays 15 that are actually obscured by obscuration 13 after being reflected from dish 28. The net footprint of obscuration 13 is therefore increased by an amount corresponding to the footprint of virtual obscuration 17.

One of the parallel, spaced apart, thermally conductive fins 1 is shown in FIG. 1C. Fins 1 are preferably planar. Fins 1 can be made of material including any suitable, thermally conductive material(s) such as metals, metal alloys, intermetallic metal compositions, amorphous metals, combinations of these, and the like. Fins 1 can be manufactured using any suitable manufacturing technique(s). Fin 1 is preferably formed by stamping aluminum sheet metal. Stamping is preferred when using aluminum inasmuch as stamping is economical and easily produces a generally planar fin 1 with two holes 5 for registering and attachment to other fins 1 and/or fins 3 and/or spacers 2.

Fin 1 also includes the cut-out regions 60 along the lower perimeter of the fin 1 which helps to avoid undue blocking of reflected sunlight by the portion of fin 1 at a position near the center of dish reflector 28.

Heat sink 20 further preferably includes one or more non-parallel fins 3. As shown in FIGS. 1B and 1G, each of the fins 3 as shown extend generally radially outward from the optical axis 24, although the projecting portions of the fins 3 are offset from axis 24 a little to accommodate the mounting holes 5 and region of fins 3 between the fold lines 21. Advantageously, at least portions of the fins 3 may be positioned within the volume of the concentrating module 26 under concentrated illumination 10 (see FIG. 2 for volume 10). Positioning at least portions of the fins 3 within the volume under concentrated illumination 10 allows large fin area without unduly increasing the wind profile and total volume of the module 26 overall.

The non-parallel fins 3 have the general shape such that they can occupy a volume extending radially from the optical axis 24 to the edge of the dish 28. While not being bound by theory, it is believed that this radial arrangement of fins 3 allows the fins 3 to extend at least partially into the volume of concentrated illumination 10 resulting in an additional, virtual obscuration. This virtual obscuration effect of positioning at least a portion of fins 3 in the volume of concentrated illumination 10 is similar to that as discussed above in FIG. 3. The virtual obscuration caused by the presence of fin 3 in the volume of concentrated illumination 10 is identical to the actual edge-on obscuration caused by the fin 3. Since the obscurations overlap, the non-parallel fins 3 are permitted to extend at least partially into the volume 10 without undue penalty. In practice, due to the finite thickness of the fins 3, there is a small amount of additional virtual obscuration that arises because rays reflected from portions of dish 28 very close to fins 3 would impinge on the sides of fins 3 as they neared the energy collection device 22. This effect is generally very small except for the region of fins 3 positioned over the region near the center of the dish 28. For this reason, fins 3 include a center cutout 61, which allows the converging cone of rays to substantially reach the energy collection device 22 without undue obstruction.

One of the non-parallel fins 3 is shown in FIG. 1D. Fins 3 are preferably planar. Fins 3 can be made of material including any suitable, thermally conductive material(s) such as metals, metal alloys, intermetallic metal compositions, amorphous metals, combinations of these, and the like. Fins 3 can be manufactured using any suitable manufacturing technique(s). The fins 3 are preferably formed by stamping aluminum sheet metal and subsequently bending along lines 21, but may include any material(s) and be manufactured using any technique(s). Stamping produces a generally planar fin with two holes 5 for registering and bonding fins 1 and 3 and spacers 2. These fins 3 have features 4 for attaching structure to the reflecting dish 28. Alternatively, attaching features 4 may attach to dish support structure independent from reflecting dish 28 (not shown). In addition to physically coupling heat sink 20 reflecting dish 28, attaching features can thermally couple heat sink 20 to reflecting dish 28 or dish support structure independent from reflecting dish 28 (not shown).

As mentioned above, fin 3 also includes the cut-out regions 61 along the lower perimeter of the fin 3 which helps to avoid undue blocking of reflected sunlight by the portion of fin 3 at a position near the center of dish reflector 28.

An enlarged view of a spacer 2 is shown in FIG. 1E. A preferred spacer 2 can be formed by stamping aluminum sheet, but spacer 2 can be made by any suitable material(s) and manufacturing technique(s). Stamping can produce a generally planar spacer 2 with two holes 5 for registering and bonding adjacent fins 1.

As shown in FIG. 1G, heatsink 20, including fins 1 and 3, is thermally coupled to the energy collection device 22 in a manner effective to help dissipate thermal energy from device 22. As mentioned above, energy collection device 22 is generally positioned at a location corresponding to focal point 9 and focal point 9 is a space where thermal energy is developed due to light being concentrated.

The heatsink 20 is designed such that the fins 1 and 3 are placed in a novel way with respect to the concentrating module 26 so that a very large fin area is achieved with little reduction in the amount of collected sunlight.

In the preferred embodiment, fins 3 provide more convection area and naturally provide a more stable mounting support due to their wider footprint, while fins 1 allow for a large amount of fin area to be packed into the center region of the reflective dish 28. The center region of reflective dish 28 includes a mechanical clearance cutout 27, which means that very little, if any, light is available for reflection in that area in any event. Thus, although a large number of fins 1 may actually block a noticeable amount of incident light, this light blocked by fins 1 is of minimal consequence since it would not be reflected by the reflective dish 28 anyway. Thus, by using both parallel fins 1 and non-parallel fins 3, maximum thermal dissipating area for cooling can be achieved with minimal obscuration of incident light.

In the preferred embodiment, the fins 1 and 3 of the heat sink 20 are aligned generally parallel with the incident rays of sunlight when the optical axis 24 is aimed at the target sun. Aligning fins 1 and 3 generally parallel with incident rays of sunlight can be accomplished by placing the fins 1 and 3 with their major faces parallel to the optical axis 24 and orienting at least fins 3 radially about the energy collection device 22, so that generally the only light that is blocked is that impinging on the thin edges of the fins 1 and 3, representing a tiny fraction of the overall incident sunlight. Referring again to FIG. 1G, each of the fins 1 and 3 includes opposed major faces that are generally parallel to the optical axis 24 of the photovoltaic concentrator module 26 associated with energy collection device 22.

An exemplary energy collection device 22 includes a photovoltaic cell. As shown in FIG. 1G, energy collection device 22 is a photovoltaic cells physically coupled to concentrator module 26.

Aiming optical axis at a target (e.g., the sun) may be accomplished with the aid of an optional sensor 29.

Optionally, one or more of the fins 1 and/or 3 may provide structural support and mechanisms with which to attach heatsink 20 to the base 28. In the preferred embodiment, such support is provided by features 4 associated with the non-parallel fins 3.

Heatsink 20 may be assembled using any technique familiar to those skilled in the art. In one technique, the heatsink 20 may be assembled by aligning alternating spacers 2 and fins 1 and 3 and subsequently attaching them using hardware such as a bolt or rivet. In another technique, the heatsink 20 may be assembled by stamping fins 1 and 3 and spacers 2 out of aluminum sheet pre-coated with a low melting point brazing material. Fins 1 and 3 and spacers 2 can be aligned and pinned and subsequent brazed together forming a structure with superior thermal conductivity between joints.

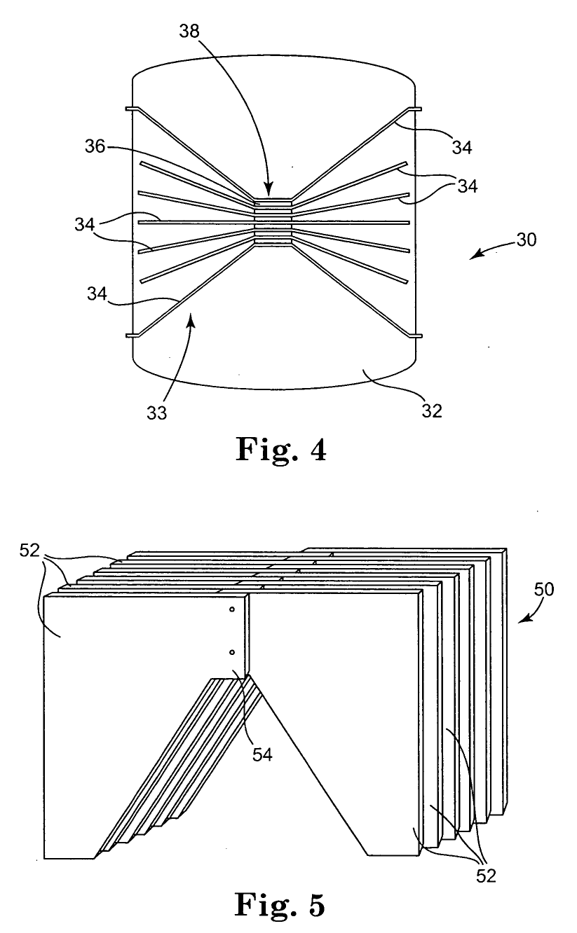

In an alternative embodiment (not shown), non-parallel fins can instead be wedge-shaped, wider at the edges of the dish 28 and narrowing to zero thickness at a position located over and near the center of dish 28. In such an embodiment, there tends to be no additional virtual obscuration. FIG. 4 shows an alternative embodiment of a portion of a photovoltaic concentrator module 30 including a dish reflector 32, and heat sink 33 including non-parallel fins 34 and spacers 36. The non-parallel fins 34 have major faces that are generally parallel with the optical axis of dish reflector 32 (the optical axis is not shown, but generally would be represented by a vertical line projecting upward from the center of the dish reflector 32 through the center stacked region 38 of heat sink 33).

FIG. 5 illustrates an alternative embodiment of a heat sink 50 including interleaved half-fins 52, which allows spacers 2 associated with fins 1 of FIGS. 1A-1G to be eliminated if desired. In this embodiment, there are half-fins 52 which extend approximately across half the width of a dish (not shown). In addition, the half-fins 52 include an extra region 54 in the center that can act as a spacer for the adjacent pair of half-fins 52. This embodiment has the benefit that it can eliminate a part (e.g. spacer 2) if desired.

What is claimed is:

1. A system, comprising;
a) an optical element having an optical axis and a focus;
b) a source of thermal energy;
c) an illuminated volume between the optical element and the focus; and
d) a heatsink thermally coupled to the source of thermal energy in a manner effective to help dissipate the thermal energy, said heatsink comprising a plurality of fins having opposed major faces that are parallel to the optical axis, wherein at least a portion of a first fin of said plurality is inside the volume and wherein at least a portion of a second fin of the plurality is outside of the volume.

2. The system of claim 1, wherein said optical axis corresponds to a direction in which sunlight is incident upon the system when the system is aimed at the sun.

3. The system of claim 1, wherein the source of thermal energy is a light source that projects light onto the optical element such that the optical element projects the light from the system, and wherein optical axis corresponds to a direction in which light is projected from the system.

4. The system of claim 3, wherein the source emits collimated light.

5. The system of claim 3, wherein the source emits semi-collimated light.

6. The system of claim 1, wherein the source of thermal energy is a photovoltaic receiver positioned in a manner such that the optical element concentrates incident light onto the photovoltaic receiver such that the illuminated volume between the receiver and the optical element is under concentrated illumination.

7. The system of claim 1, wherein the second fin is a constituent of a stack including a plurality of spaced apart fins having major faces that are parallel to the optical axis.

8. The system of claim 7, wherein a support structure attaches the stack to the system, said support structure comprising the first fin.

9. The system of claim 8, wherein the first fin is radially oriented with respect to the optical axis.

10. The system of claim 1, wherein the first fin is radially oriented with respect to the optical axis.

11. The system of claim 1, wherein the second fin is positioned generally outside of the illuminated volume and includes a first portion that has a perimeter that is adjacent to and follows a boundary of the illuminated volume.

12. The system of claim 11, wherein the focus is above the optical element, and wherein the second fin includes an additional portion that is positioned outside the illuminated volume and that extends above the focus.

13. The system of claim 7, wherein a spacer is interposed between the second fin and an additional fin of the stack.

14. The system of claim 7, wherein the spaced apart fins of the stack are interleaved.

15. The system of claim 1, further comprising a dish reflector having a central optical axis and wherein the first fin is radially oriented with respect to the central optical axis.

16. The system of claim 15, wherein the first fin is coupled to the dish reflector and supports the second fin.

17. A system comprising;
a) an optical element having an optical axis and a focus;
b) an illuminated volume between the optical element and the focus; and
c) a heat sink thermally coupled to the system, wherein at least a portion of the heatsink is positioned in said volume.

18. The system of claim 17, wherein the heat sink comprises a fin having a major face parallel to the optical axis.

19. The system of claim 18, wherein the heat sink further comprises a stack of spaced apart fins coupled to the system in a manner effective to help dissipate thermal energy from the system.

20. The system of claim 18, wherein the optical element is a dish reflector and wherein the fin is oriented radially with respect to the optical axis.

21. The system of claim 20, further comprising an additional fin that is positioned radially with respect to the central optical axis.

22. The system of claim 21, further comprising at least one fin positioned parallel to the central optical axis, and wherein the radially positioned fins support the at least one fin.

23. The system of claim 17, wherein a photovoltaic cell is positioned in a manner effective to receive light concentrated by the optical element.

24. The system of claim 23, wherein the photovoltaic cell and the optical element are constituents of an articulatable module supported upon a fixed frame.

25. A system comprising;
a) an optical element having an optical axis and a focus;
b) an illuminated volume between the optical element and the focus; and
c) a heatsink thermally coupled to the system, wherein the heatsink comprises a fin having a major face parallel to the optical axis and having a first portion that has a perimeter that is adjacent to and follows a boundary of the illuminated volume.

26. The system of claim 25, wherein the focus is above the optical element and wherein the fin includes an additional portion that is positioned outside the illuminated volume and that extends above the focus.

27. The system of claim 25, wherein a photovoltaic cell is positioned at the focus and wherein the optical element concentrates incident light onto the cell.

28. The system of claim 25 wherein the optical element projects incident light from the system.

29. A photovoltaic power system, comprising at least one articulating photovoltaic concentrator module, said module comprising:
a) at least one photovoltaic cell;
b) an optical element that has a focus on a focal plane and that concentrates incident light onto the photovoltaic cell, wherein said optical element has an optical axis, and wherein said concentrating generates thermal energy;
c) a volume under concentrated illumination between the optical element and the photovoltaic cell; and
d) a heatsink comprising at least one heat dissipating fin that is thermally coupled to the photovoltaic cell in a manner effective to help dissipate thermal energy from the module, said fin having opposed major faces that are generally parallel to the optical axis of the optical element, and said fin having a portion that is positioned inside a volume between the focal plane and the optical element.

30. A photovoltaic power system, comprising at least one articulating photovoltaic concentrator module, said module comprising:
a) at least one photovoltaic cell
b) an optical element that has a focus on a focal plane and that concentrates incident light onto the photovoltaic cell, wherein said optical element has an optical axis, and wherein said concentrating generates thermal energy;
c) a volume under concentrated illumination between the optical element and the photovoltaic cell; and
d) a heatsink comprising at least one heat dissipating fin that is thermally coupled to the photovoltaic cell in a manner effective to help dissipate thermal energy from the module, said fin having opposed major faces that are generally parallel to the optical axis of the optical element, and said fin having a first portion that is positioned outside the volume under concentrated illumination and has a perimeter that is adjacent to and follows a boundary of the illuminated volume and having a second portion that is positioned outside the volume under concentrated illumination and extends above the focus.

31. A heat sink for dissipating thermal energy, comprising:
a) a stack of spaced apart fins, said fins having major faces parallel to an axis;
b) an open volume below the stack; and
c) at least a portion of a fin positioned in the open volume and having major faces parallel to the axis.

32. The heat sink of claim 31, wherein the fin having a portion inside the open volume is an additional fin having major faces that are nonparallel with respect to the fins of the stack.

33. The heat sink of claim 31, wherein the heat sink further comprises a plurality of fins having respective portions positioned in the open volume and having major faces parallel to the axis.

34. The heat sink of claim 33, wherein the additional fins extend radially from an axis that is parallel to the major faces of the additional fins.

35. The heat sink of claim 34, wherein the additional fins are coupled to the stack.

36. The heat sink of claim 34, wherein the additional fins are coupled to and support the stack.

37. The heat sink of claim 31, wherein the fins of the stack are parallel to each other.

38. The heat sink of claim 31, wherein the open volume under the stack is conical and wherein lower perimeter of the fins of the stack are shaped to follow the boundary of the conical open volume under the stack.

39. The heat sink of claim 31, wherein the open volume under the stack is conical and wherein the fins of the stack are positioned outside said volume.

40. A heat sink for dissipating thermal energy, comprising:
a) a stack of spaced apart fins, said fins having major faces parallel to an axis;
b) an open volume below the stack; and
c) a plurality of additional fins positioned at least partially in the open volume below the stack, said additional fins having major faces parallel to the axis and extending radially from the axis, and said additional fins supporting the stack.
